(19) United States
(12) Patent Application Publication
(10) Pub. No.: US 2014/0078730 A1
(43) Pub. Date: Mar. 20, 2014

(54) LAMP SYSTEM HAVING PARABOLIC REFLECTOR WITH TWO REFLECTIONS FOR RECYCLING LIGHT

(71) Applicant: WAVIEN, INC., Valencia, CA (US)

(72) Inventor: Kenneth LI, Castaic, CA (US)

(73) Assignee: WAVIEN, INC., Valencia, CA (US)

(21) Appl. No.: 14/027,646

(22) Filed: Sep. 16, 2013

Related U.S. Application Data
(60) Provisional application No. 61/702,451, filed on Sep. 18, 2012.

(51) Int. Cl. F21V 7/06

(52) U.S. Cl. CPC F21V 7/06
USPC 362/231; 362/296.08

(57) ABSTRACT

A lamp system comprises a light source and a parabolic reflecting collar positioned around the light source and having an aperture through which a center axis extends. The aperture permits light rays emitted by the light source at low angles relative to the axis to be emitted from the parabolic reflecting collar, while light rays emitted by said light source at higher angles are reflected by the collar for recycling. The parabolic reflecting collar is positioned such that higher angle light rays are reflected twice, off opposing wall reflecting portions, back to their point of origin. Preferably the light source is an array of multiple LEDs having different colors and sizes.

### CROSS-REFERENCE TO RELATED APPLICATIONS

The present application claims priority on U.S. provisional application No. 61/702,451, filed on Sep. 18, 2012.

### BACKGROUND OF THE INVENTION

Lamps having spherical reflectors have been used with LEDs to recycle light so as to increase the brightness of the output. As shown in FIG. 1, the LED 10, which may be mounted on a heat sink 12, is placed at the center of curvature 14 of a hemispherical recycling collar 16 having a reflective surface. The collar 16 includes a cutout which forms an aperture 18. Light rays 20 emitted from the LED 10 at a relatively low angle relative to the central axis 22, i.e., less than angle a, are emitted from the device, whereas light rays 24 emitted from the LED at larger angles, i.e., greater than α, are reflected back to the LED 10 for recycling.

The collar 16 provides a high recycling efficiency. The size of the aperture 18 determines the amount of recycling. The smaller the aperture, the higher the percentage of recycling and the brighter the output of the system.

As shown in FIG. 1, high angle light rays 24 which are emitted from the center of the LED 10 will be reflected back to the center of the LED 10. Light rays 26 emitted from a location which is off-center will be reflected back in a mirror image fashion, in a direction 26a, which is also off-center but located on the opposite side of the LED surface.

For lamps having a single LED (or other light source), the system just described will recycle all large angle light rays 24 back onto the LED 10 for recycling. However, for lamps having multiple light sources, such as multiple color LEDs, the system will reflect high angle light rays back to the same LED 10 if such LED is located at the center of curvature of the collar 16. If the light source in FIG. 1, instead of being a single LED 10, were to constitute multiple LEDs, at most only one of the LEDs could be located at the center of curvature 14 and have high angle light rays recycled back to the same LED. The remaining light sources would necessarily be located off-center. As shown by FIG. 1, if the LED 10 were to constitute two LEDs on opposite side of the center 14, high angle light rays 26 emitted from an LED located off-center on the right side of the center of curvature will be reflected by the surface of the back in the direction 26a to the LED located on the opposite side of the center 14, i.e., will impact a different LED than the emitting LED (or other light source). The result is that high angle light rays 26 emitted off-center will not be recycled unless the LED on the opposite side of center is of the same color as the LED which emitted the light ray 26.

It would be desirable to provide a lamp in which multiple light sources may be used, and at the same time provide efficient recycling of high angle light rays 24, 26 emitted from the center of the light array as well as emitted from the center 14. It would also be desirable to provide a system in which LEDs located on opposite sides of the center may be of different colors and in which the system provides recycling of high angle light rays 26.

### SUMMARY OF THE INVENTION

A lamp system comprises a light source and a parabolic reflecting collar positioned around the light source and having an aperture through which a center axis extends. The aperture permits light rays emitted by the light source at low angles relative to the axis to be emitted from the parabolic reflecting collar, while light rays emitted by said light source at higher angles are reflected by the collar for recycling.

The parabolic reflecting collar is made by rotating the parabolic curve around the axis which goes through the focus and is parallel to the directrix. The resulting reflector is round with a parabolic surface. Light emitted from the LED placed at the focus is reflected from one side of the parabolic surface, becomes a parallel beam, incidence onto the opposite parabolic surface, and refocused back to the LED itself. One major difference between this parabolic recycling collar and the spherical recycling collar as shown in FIG. 1 is that the light emitted from a point at and near the focus will be reflected by the parabolic reflector twice and back to the same point where the light is emitted. With this property, with used with packages with multiple LEDs and multiple colors, each LED will be able to perform recycling of its own light independently and each LED with its own color will be able to improve the brightness independent of the other LEDs and colors.

The parabolic reflecting collar is positioned such that higher angle light rays are reflected twice, off opposing wall reflecting portions, back to their point of origin. Preferably the light source is an array of multiple LEDs having different colors and sizes.

### BRIEF DESCRIPTION OF THE DRAWINGS

FIG. 1 is a schematic drawing of a prior art lamp with a hemispherical recycling collar;

FIG. 2 is a schematic drawing of a lamp system according to the invention;

FIG. 3 shows schematically a light source array consisting of two green, one red, and one blue LED;

FIG. 4 shows schematically a light source array similar to FIG. 3, but in which the LEDs are of different sizes relative to one another;

FIG. 5 is a schematic drawing of a lamp system similar to FIG. 2, but using the light source array of FIG. 3;

FIG. 6 is a picture, in perspective view, of a commercially available multi-color LED array;

FIG. 7 is a schematic drawing of spot light using the lamp system of FIG. 5;

FIG. 8 is a schematic drawing of a lamp system, similar to FIG. 2, which uses a microwave plasma bulb as the light source; and

FIG. 9 is a schematic drawing of a projection system which uses the lamp system of FIG. 5.

### DETAILED DESCRIPTION OF THE INVENTION

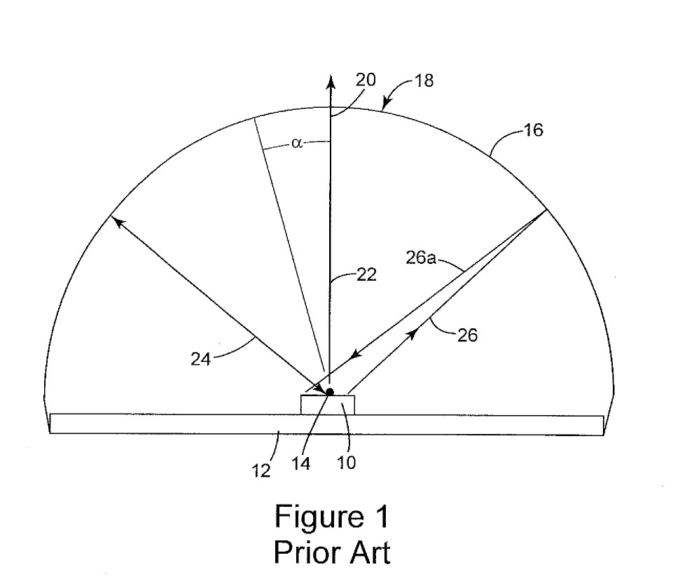

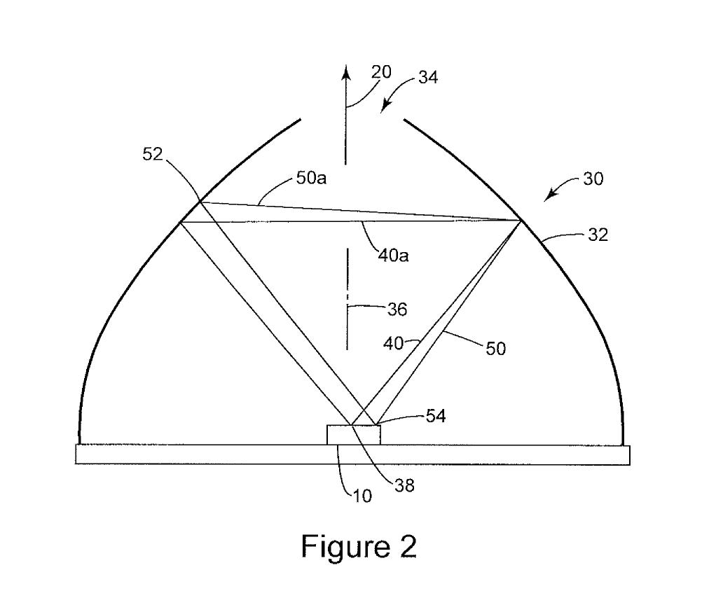

Referring to FIG. 2, a lamp system 30 according to the invention includes a light source, for example an LED 10. The light source is surrounded by a collar 32 having a reflective surface and an aperture 34 centered about the axis 36 of the lamp. As in the case of FIG. 1, the aperture 34 permits emitted light rays having an emission angle, relative to the axis 36, below a predetermined angle, tube emitted from the lamp system, and at the same time causing light rays having an emission angle greater than such predetermined angle, to be reflected off the surface of the collar 32.

In accordance with the present invention, the collar, in cross-section (as depicted in FIG. 2), has a parabolic shape on either side, which converges in the direction in which light is emitted. The light source, e.g., LED 10, is centrally positioned within the parabolic collar 32. The collar 32 is spaced and oriented relative to the light source 10 such that light rays 20 emitted at a relatively low angle relative to the axis 36 are emitted through the opening 34, and such that higher angle light rays 40 emitted from the center point 38 of the LED reflect off the parabolic collar 32 in a direction perpendicular to the axis 36. The reflected light rays 40a are directed to an opposing wall of the collar 32, where they reflect back towards the LED 10. The twice reflected light rays 40b are directed back towards the LED 10 at an angle which is a mirror image of the angle of the light ray 40 (the light rays 40 and 40b are 90 degrees apart).

FIG. 2 also illustrates that high angle light rays 50 which are emitted from off-center locations of the LED 10 are reflected by the first parabolic surface in a direction which is not perpendicular to the axis 36, i.e., such that the angle of reflection of ray 50 is greater than the angle of reflection of ray 40. The reflected ray 50a strikes the opposite parabolic surface at a point 52, and is reflected back to the point of origination 54. Thus the first-reflected ray 50a is reflected by the second parabolic surface at an angle which is less than the angle of reflection of ray 40a.

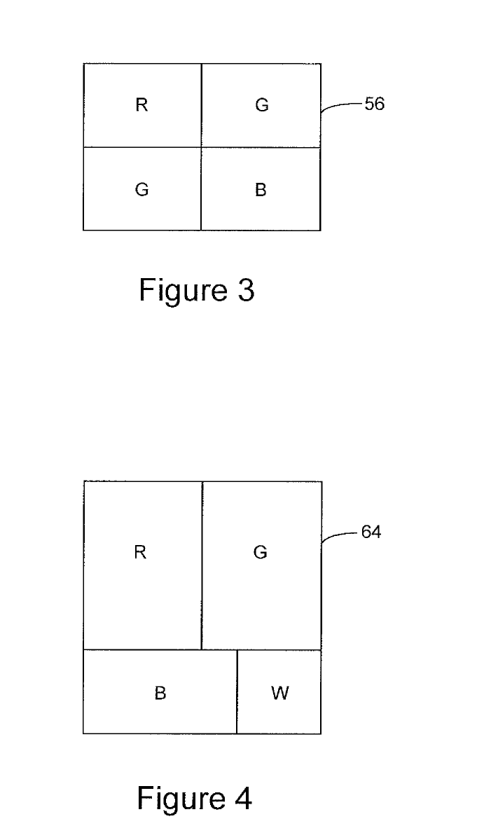

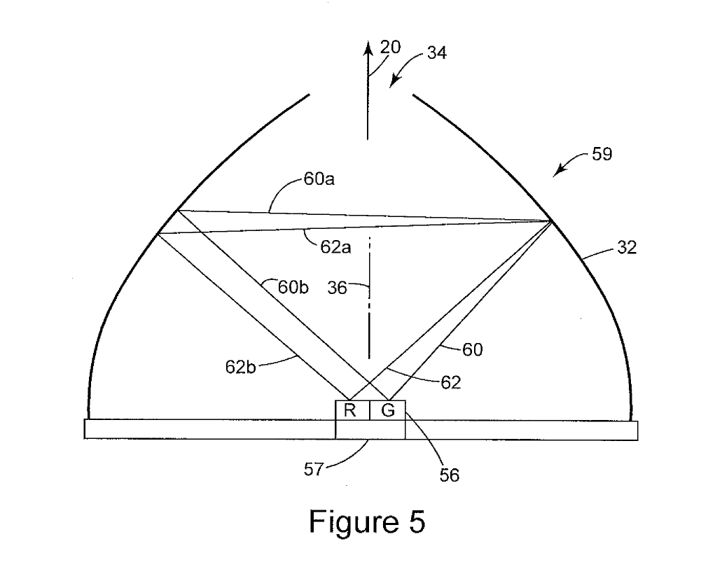

Referring to FIGS. 3 and 5, FIG. 3 shows an example of a multi-color light source array in the form of a RGGB LED array 56 with two green LEDs, one red LED, and one blue LED assembled on the same heat sink 57 (see FIG. 5). FIG. 5 shows a lamp system 59 which uses the RGGB array 56 of FIG. 3 and the recycling collar 32 of FIG. 2. If the RGGB array 56 is centered relative to the center axis 36, light emitted from the red and green LEDs will be emitted off-center of the axis, on opposite sides. However, due to the presence of the dual parabolic collar 32, high angle light rays 60 emitted from the green LED R will be reflected back to the green LED, as reflected rays 60a and 60b, and high angle rays 62 from the red LED R will be reflected back to the red LED as reflected rays 62a and 62b.

FIG. 4 shows another example of a multi-color light source 64 consisting of a red LED R, a green LED G, a blue LED B, and a white LED W. The four LEDs are mounted on the same heat sink (not shown). Because the parabolic collar 32 will reflect high angle light rays 60, 62 back to the same point on the LED where the ray was emitted, as illustrated by FIG. 4 the LEDs may be of different sizes.

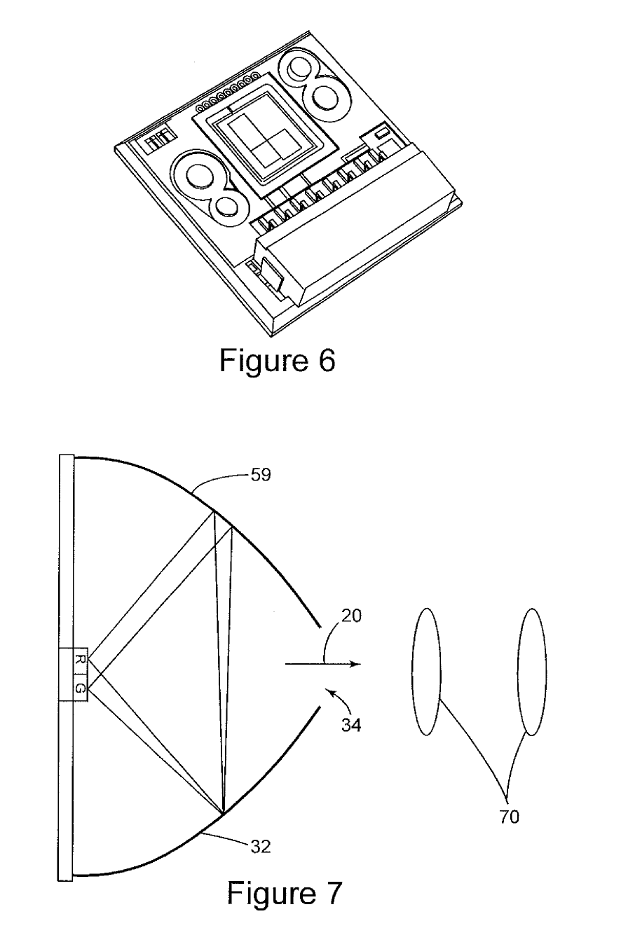

FIG. 6 is a picture of a commercially available LED array, corresponding to FIG. 4, which is marketed by Luminous Devices, Inc. in Billerica, Mass. Such LED array is used in many applications such a in spot lights and stage lighting, where multiple colors are normally required.

FIG. 7 is an example of a spot light using the lamp system 59 of FIG. 5. Light rays 20 emitted through the aperture 34 are directed through a lens system 70 to shape the output beam 20 into the desired divergence. The color of the output can be controlled by driving the LEDs in the array 56 with the appropriate power.

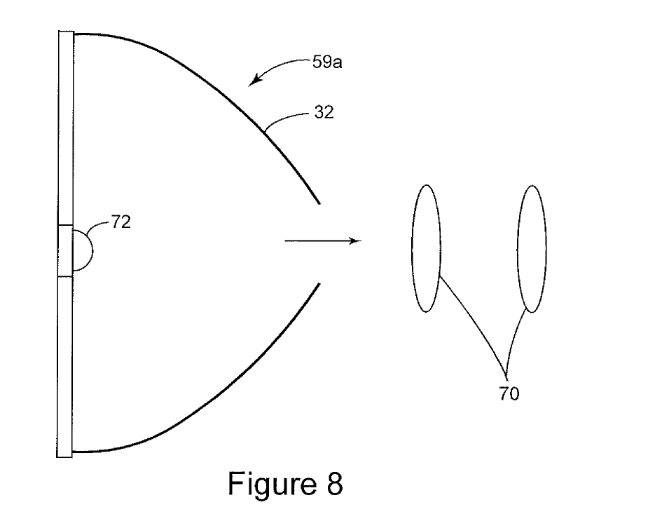

FIG. 8 is an alternative embodiment of a spotlight which is the same as FIG. 7, except that the light source of the lamp system 59a is a microwave plasma bulb 72 of a single color. In this case, the imaging property of the dual parabolic recycling collar 32 allows greater tolerance in the alignment of the system insofar as any deviation of the light source from the center will image back onto the light source 72.

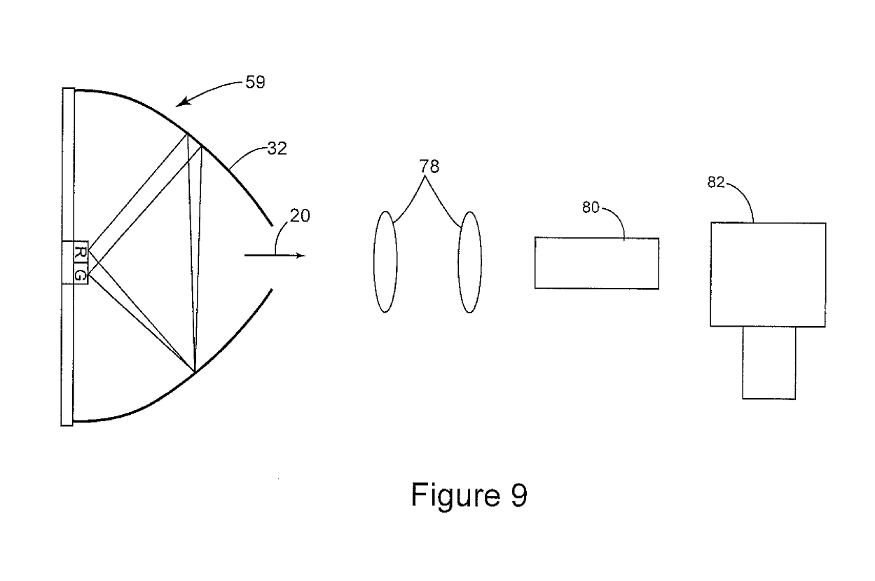

FIG. 9 shows an example of a projection system 76 using the lamp system 59 of FIG. 5. As in the system of FIG. 7, light rays 20 emitted through the aperture 34 are directed through a lens system 78. The beam is then directed through a light tunnel 80 and thereafter to an input of a projection engine 82. The use of lens systems, light tunnels and projection engines are well known and need not be further described.

In each of the described embodiments, the recycling of the high angle light rays 40, 50, 60, and 62 so as to reflect back to the point of emission increases the brightness of the lamp system 30, 59, and 59a and reduces the entendue of the lamp system.

The parabolic recycling collar 32 can be made of metal, glass, or plastic. The reflective coating can be aluminum, silver, or multi-layer dielectric coating targeting certain wavelengths.

The foregoing description represents the preferred embodiments of the invention. Various modifications will be apparent to persons skilled in the art. All such modifications and variations are intended to be within the scope of the invention, as set forth in the following claims.

1. A lamp system comprising:
a light source;
a parabolic reflecting collar positioned around said light source and having an aperture through which a center axis extends;
wherein said aperture permits light rays emitted by said light source at low angles relative to said axis to be emitted from said parabolic reflecting collar and reflects light rays emitted by said light source at higher angles for recycling; and
wherein said parabolic reflecting collar is positioned such that higher angle light rays are reflected twice, off opposing wall reflecting portions, back to their point of origin.

2. The lamp system of claim 1, wherein said light source is an array having multiple color sources, and wherein said parabolic reflecting collar reflects higher angle light rays twice back to each respective color source.

3. The lamp system of claim 1, wherein said light source comprises at least one LED.

4. The lamp system of claim 3, wherein said light source comprises multiple LEDs of different colors.

5. The lamp system of claim 4, wherein said LEDs are of varying sizes relative to one another.

6. The lamp system of claim 1, wherein said light source is a microwave plasma bulb of a single color LED.

7. A spotlight having the lamp system of claim 4.

8. A projection system having a projection engine with an input for receiving the output of the lamp system of claim 4.
